(19) United States
(12) Patent Application Publication
(10) Pub. No.: US 2008/0078045 A1
(43) Pub. Date: Apr. 3, 2008

(54) Eyeglasses Cleaning Device

(76) Inventor: Allen TSAI, Taipei City (TW)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(21) Appl. No.: 11/618,958

(22) Filed: Jan. 2, 2007

(30) Foreign Application Priority Data
Oct. 3, 2006 (TW) 095136715

(51) Int. Cl. G02C 13/00

(52) U.S. Cl. 15/214; 15/118; 15/244.1

(57) ABSTRACT

An eyeglasses cleaning device includes: a holding body defining an inner space therein and adapted to receive a cleaning cloth in the inner space, the holding body having a connecting end; and at least one cleaning unit including a mounting member that is coupled detachable to the connecting end of the holding body, and a soft porous block that is mounted on the mounting member and that is adapted to absorb a liquid cleaner therein.

### CROSS-REFERENCE TO RELATED APPLICATION

This application claims priority of Taiwanese Application No. 095136715, filed on Oct. 3, 2006.

### BACKGROUND OF THE INVENTION

1. Field of the Invention

The invention relates to an eyeglasses cleaning device, more particularly to an eyeglasses cleaning device including a cleaning unit having a soft porous block adapted to absorb a liquid cleaner therein.

2. Description of the Related Art

Conventional methods of cleaning eyeglasses are normally carried out by using solely a clean cloth, which is not effective and which tends to result in abrasion or scratches on the eyeglasses, or using a detergent during washing with water and then wiping with a clean cloth, which is relatively inconvenient.

### SUMMARY OF THE INVENTION

Therefore, the object of the present invention is to provide an eyeglasses cleaning device that can overcome the aforesaid drawbacks associated with the prior art.

Accordingly, an eyeglasses cleaning device of this invention comprises: a holding body defining an inner space therein and adapted to receive a cleaning cloth in the inner space, the holding body having a connecting end; and at least one cleaning unit including a mounting member that is coupled detachably to the connecting end of the holding body, and a soft porous block that is mounted on the mounting member and that is adapted to absorb a liquid cleaner therein.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of the first preferred embodiment of an eyeglasses cleaning device according to the present invention;

FIG. 2 is an exploded sectional view of the first preferred embodiment;

FIG. 3 is a partly exploded sectional view of the first preferred embodiment;

FIG. 4 is a partly exploded perspective view illustrating the configuration of a soft porous block of a cleaning unit of the first preferred embodiment;

FIG. 5 is a perspective view of a modified soft porous block modified from the first preferred embodiment; and

FIG. 6 is a partly exploded sectional view of the second preferred embodiment of the eyeglasses cleaning device according to this invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

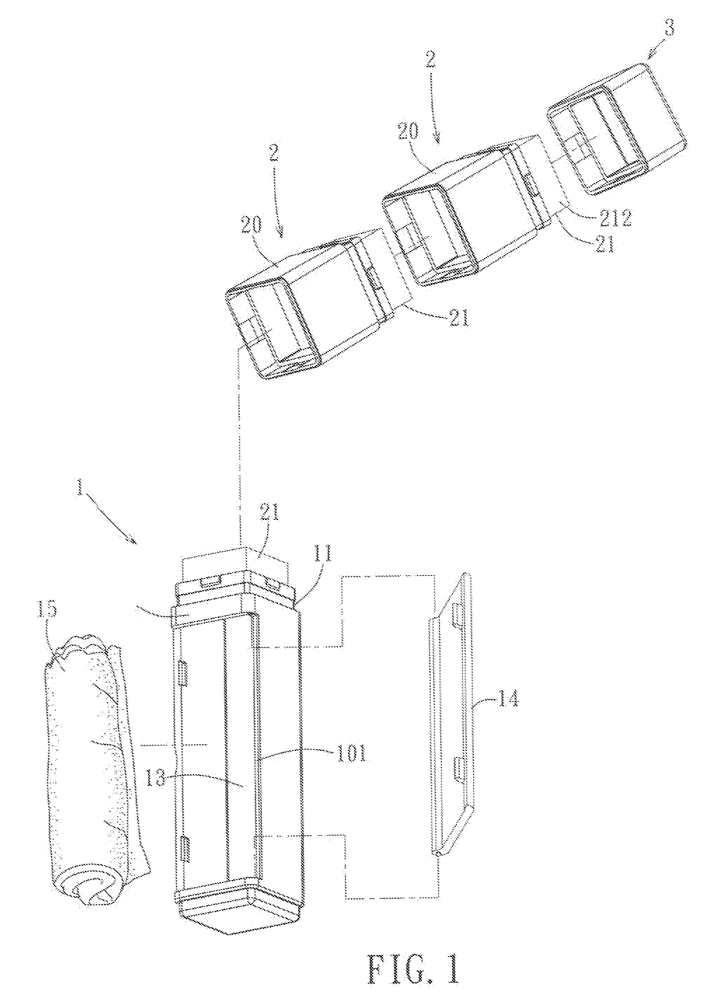

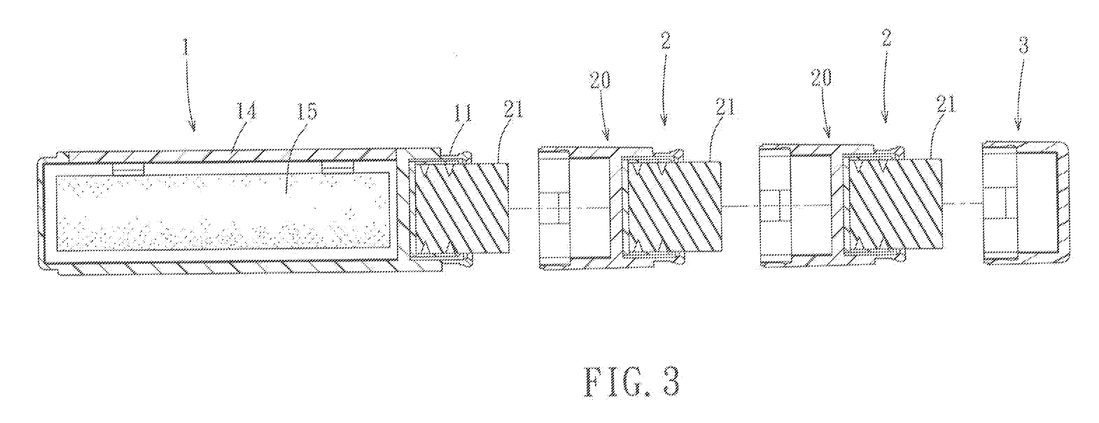

As shown in FIGS. 1 to 3, the first preferred embodiment of an eyeglasses cleaning device according to the present invention includes: a holding body 1 defining an inner space 13 therein and adapted to receive a cleaning cloth 15 in the inner space 13, the holding body 1 having a connecting end 11; and at least one cleaning unit 2 (in this embodiment, two of the cleaning units 2 are provided and are connected in series) including a mounting member 20 that is coupled detachable to the connecting end 11 of the holding body 1, and a soft porous block 21 that is mounted on the mounting member 20 and that is adapted to absorb a liquid cleaner therein.

The mounting member 20 of each of the cleaning units 2 is hollow, and has a surrounding wall 200 that has a first end portion 201 defining a first inner space 24 and connected detachably to the connecting end 11 of the holding body 1, and a second end portion 202 extending from the first end portion 201 and defining a second inner space 23. The mounting member 20 further has a partitioning wall 22 that separates the first and second inner spaces 24, 23. The soft porous block 21 of each of the cleaning units 2 is inserted into the second inner space 23 in the mounting member 20 of a respective one of the cleaning units 2, and extends outwardly therefrom.

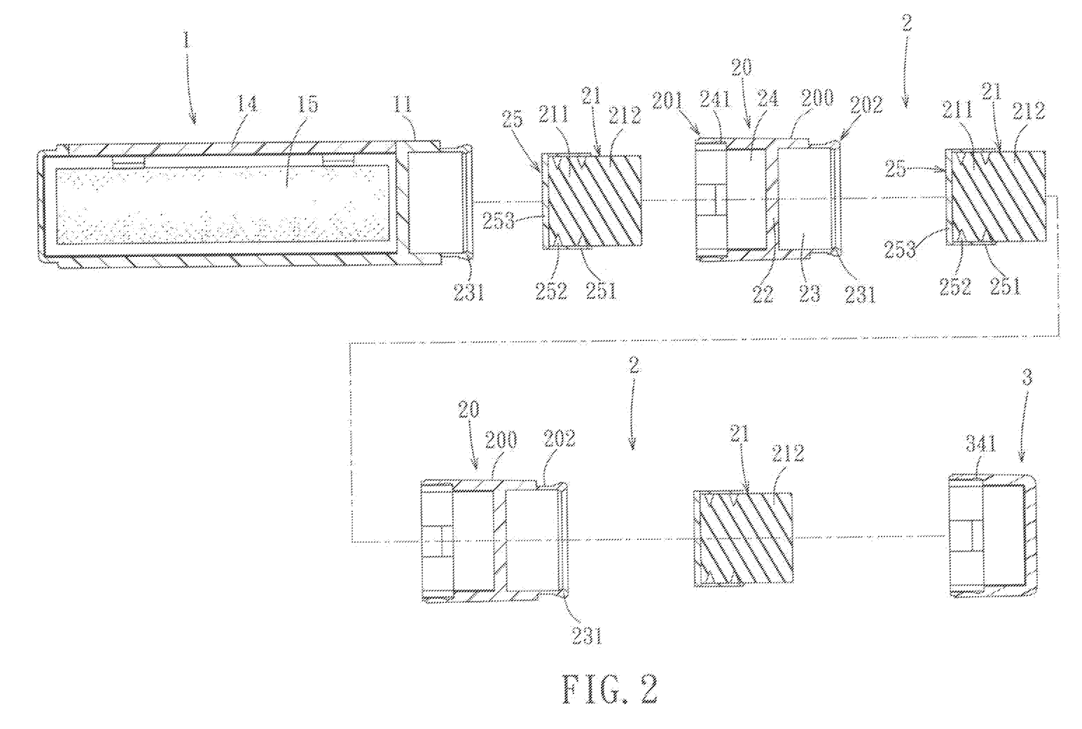

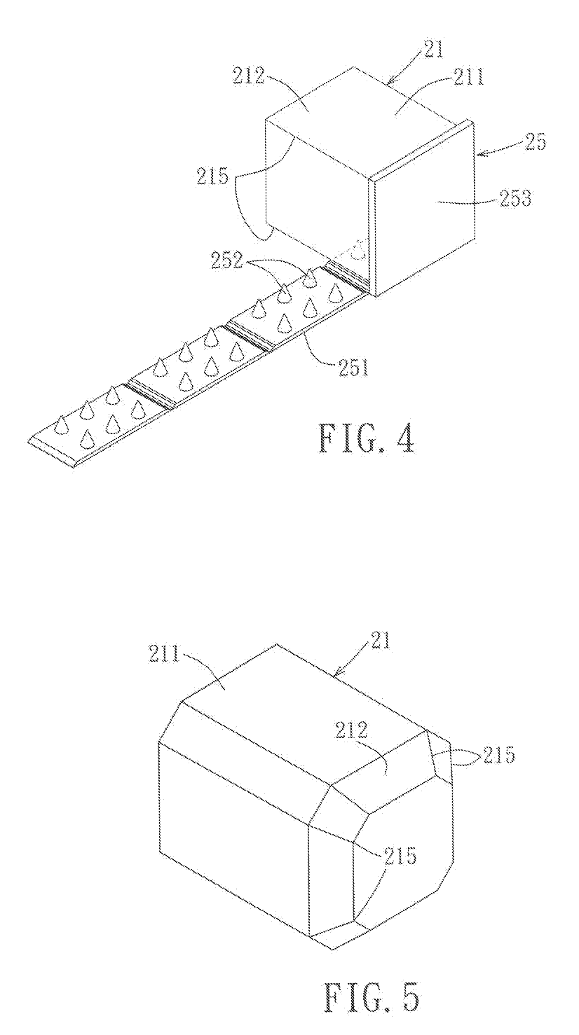

The soft porous block 21 of each of the cleaning units 2 has a first end portion 211 and a second end portion 212 extending from the first end portion 211. Each of the cleaning units 2 further includes a casing 25 wrapping around the first end portion 211 of the soft porous block 21, and fitted snugly into the second inner space 23 in the mounting member 20 of the respective one of the cleaning units 2. The casing 25 has a surrounding wall 251 formed with a plurality of inner retaining teeth 252 (see FIGS. 2 and 4) protruding into the first end portion 211 of the soft porous block 21, and a bottom wall 253 abutting against the soft porous block 21. Alternatively, the soft porous block 21 can be secured adhesively to the casing 25 using an adhesive. The surrounding wall 251 of the casing 25 is unfodable (see FIG. 4). In this embodiment, the soft porous block 21 is made from sponge 210, and has a square cross-section with four sharp corners 215 (see FIG. 4).

The holding body 1 is generally rectangular in shape. The connecting end 11 of the holding body 1 has the same structure as the second end portion 202 of the surrounding wall 200 of the mounting member 20 of each of the cleaning units 2. The first end portion 201 of the surrounding wall 200 of the mounting member 20 of one of the cleaning units 2, which is disposed adjacent to the holding body 1, is sleeved on the connecting end 11 of the holding body 1. In this embodiment, the connecting end 11 of the holding body 1 cooperates with the first end portion 201 of the surrounding wall 200 of the mounting member 20 of the adjacent one of the cleaning units 2 to accommodate on additional soft porous block 21 and an additional casing 25 wrapping around the additional soft porous block 21.

The connecting end 11 of the holding body 1 and the second end portion 202 of the surrounding wall 200 of the mounting member 20 of each of the cleaning units 2 is provided with a first interlocking member 231. The first end portion 201 of the surrounding wall 200 of the mounting member 20 of each of the cleaning units 2 is provided with a second interlocking member 241. The first interlocking member 231 on the connecting end 11 of the holding body 1 engages the second interlocking member 241 on the first end portion 201 of the surrounding wall 200 of the mounting member 20 of the adjacent one of the cleaning units 2 in a tongue-and-groove engaging manner so as to permit secured connection between the holding body 1 and the adjacent one of the cleaning units 2. A cap 3 is sleeved on the second end portion 202 of the surrounding wall 200 of the mounting member 20 of the adjacent one of the cleaning units 2 for covering the second end portion 212 of the soft porous block 21 of an adjacent one of the cleaning units 2, and is provided with an interlocking member 341 that has the same structure as the second interlocking member 241 and that engages the first interlocking member 231 on the second end portion 202 of the surrounding wall 200 of the mounting member 20 of the adjacent one of the cleaning units 2.

In this embodiment, each of the first interlocking members 231 is in the form of an outer protrusion, and each of the second interlocking members 241 is in the form of an inner groove.

The holding body 1 is formed with an opening 101 on a lateral side thereof for access to the cleaning cloth 15 in the inner space 13, and has a cover 14 for covering and uncovering the opening 101.

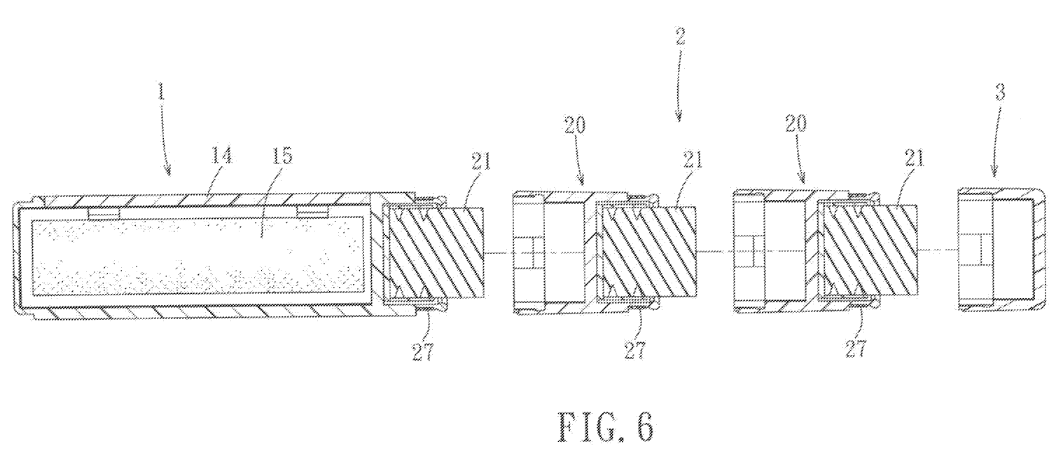

FIG. 5 illustrates a modified soft porous block 21 that has eight lateral faces defining eight corners 215 thereamong.

FIG. 6 illustrates the second preferred embodiment of the eyeglasses cleaning device according to this invention. The second preferred embodiment differs from the previous embodiment in that each of the cleaning units 2 further includes an elastic sealing ring 27 sleeved sealingly on the second end portion 202 of the surrounding wall 200 of the mounting member 20. In addition, the connecting end 11 of the holding body 1 is also provided with an elastic sealing ring 27. The elastic sealing ring 27 on the second end portion 202 of the surrounding wall 200 of the mounting member 20 of one of the cleaning units 2, which is disposed adjacent to the cap 3, is in sealing contact with the cap 3 so as to prevent the liquid cleaner from seeping out of the mounting member 20.

From the foregoing, the advantages of this invention can be summarized as follows:

1) the soft porous block 21 is pre-wetted with an appropriate amount of the liquid cleaner and is readily useable for cleaning eyeglasses;

2) the sharp corners 215 of the soft porous block 21 can easily remove the dirt on the eyeglass without resulting in abrasion or scratches; and

3) the soft porous blocks 21 are replaceable and the number of the cleaning units 2 can be increased based on the actual requirements.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An eyeglasses cleaning device comprising:
a holding body defining an inner space therein and adapted to receive a cleaning cloth in said inner space, said holding body having a connecting end; and
at least one cleaning unit including a mounting member that is coupled detachably to said connecting end of said holding body, and a soft porous block that is mounted on said mounting member and that is adapted to absorb a liquid cleaner therein.

2. The eyeglasses cleaning device as claimed in claim 1, wherein said mounting member is hollow and has a surrounding wall that has a first end portion defining a first inner space and connected detachably to said connecting end of said holding body, and a second end portion extending from said first end portion and defining a second inner space, said mounting member further having a partitioning wall that separates said first and second inner spaces, said soft porous block being inserted into said second inner space and extending outwardly therefrom.

3. The eyeglasses cleaning device as claimed in claim 2, wherein said soft porous block has a first end portion, said cleaning unit further including a casing wrapping around said first end portion of said soft porous block, and fitted snugly into said second inner space in said mounting member, said casing having a surrounding wall formed with a plurality of inner retaining teeth protruding into said first end portion of said soft porous block.

4. The eyeglasses cleaning devices as claimed in claim 3, wherein said first end portion of said surrounding wall of said mounting member is sleeved on said connecting end of said holding body, said connecting end of said holding body being provided with a first interlocking member, said first end portion of said surrounding wall of said mounting member being provided with a second interlocking member that engages releasably said first interlocking member in a tongue-and-groove engaging manner.

5. The eyeglasses cleaning device as claimed in claim 4, wherein said soft porous block further has a second end portion extending from said first end portion of said soft porous block, said eyeglasses cleaning device further comprising a cap sleeved on said second end portion of said surrounding wall of said mounting member for covering said second end portion of said soft porous block.

6. The eyeglasses cleaning device as claimed in claim 5, wherein said cleaning unit further including an elastic sealing ring sleeved sealingly on said second end portion of said surrounding wall of said mounting member and in sealing contact with said cap.

7. The eyeglasses cleaning device as claimed in claim 1, wherein said soft porous block is made from sponge.

8. The eyeglasses cleaning device as claimed in claim 1, wherein said soft porous block has a plurality of sharp corners.

9. The eyeglasses cleaning device as claimed in claim 3, wherein said soft porous block is secured adhesively to said casing.
